(19) United States
(12) Patent Application Publication
(10) Pub. No.: US 2005/0198202 A1
(43) Pub. Date: Sep. 8, 2005

(54) Method for causing server to provide client computers with annotation functions for enabling users of the client computers to view object-based documents with annotations

(76) Inventor: Shinichirou Yamamoto, Nagoyashi (JP)

Correspondence Address: HEIMBECHER & ASSOCIATES, LLC., 390 UNION BLVD, SUITE 650, LAKEWOOD, CO, 80228-6512, US

(21) Appl. No.: 10/886,657

(22) Filed: Jul. 7, 2004

(30) Foreign Application Priority Data
Jan. 7, 2004 (JP) 2004-002525

(51) Int. Cl. G06F 15/16

(52) U.S. Cl. 709/218; 715/501.1

(57) ABSTRACT

A server is caused to provide to a client computer an annotation function available to other client computers to thereby allow the client computer to communicate with the other client computers using annotations. The server stores on the server viewing information that allows a user of the client computer to view a document with an attached annotation on a screen of the client computer, and the server transmits the viewing information to the client computer. The viewing information includes: document information representing the document in a web-viewable format, such that the document is defined so as to be classified into a plurality of objects which are capable of being designated individually; annotation information representing the annotation in a web-viewable format; and a script to be executed by the client computer for allocating the annotation to the document.

### CROSS REFERENCE TO RELATED APPLICATIONS

This application claims priority pursuant to 35 U.S.C.§119 to Japanese Patent Application No. 2004-002525 filed 7 Jan. 2004, the content of which is hereby incorporated by reference as though fully set forth herein.

### BACKGROUND OF THE INVENTION

a. Field of the Invention

The present invention relates to techniques of causing a server to provide a plurality of client computers with annotation functions, thereby to allow the users of the client computers to communicate with each other using annotations.

b. Description of the Related Art

Generally, software is so composed as to include a variety of software-related documents, such as source programs, design specifications, and design documents or design descriptions. These software-related documents hold official or formal information (shared information) with which all the members of a group on a software development project are involved, and are each classified as a type of information to be maintained and administrated over a longer time. The software-related documents each belong to a type of information containing a large amount of document data. Alternately, another type of information exists that is relatively private, personal, or informal, that is stored and administered transitorily or temporarily, and that contains a small amount of document data. Currently, the private, transitory, and small-scale information is merely administered transitorily and is for personal use only. However, the private, transitory, and small-scale information plays a vital role and is important in supporting development and maintenance of software.

An annotation or note is utilized to administer private, transitory, and small-scale information. Originally, an annotation is utilized for leaving a note or a memorandum and for putting a mark at such a location in a destination document that the author and readers of the destination document are focusing on. When an annotation, once made in a destination document, has become unnecessary, it can be removed easily from the destination document. Information represented by an annotation is a type of information to function as a private note or to be circulated among a small number of people, and the retention period or the stock period of the information is relatively short.

In the event of viewing or reviewing a source program, it is customary for a worker to add new findings and/or unclear things to annotations for storage, and to put a mark at an important location in the source program with a marking pen. Such a type of information as to be represented by an annotation or a marking pen is a typical example of private, transitory, and small-scale information. Therefore, in development and maintenance of software, an annotation is suitable for use in administering private, transitory, and small-scale information.

As described above, an annotation is originally utilized for leaving a note or a memorandum and for putting a mark at such a location in a destination document that the author and readers of the destination document are focusing on. Now, consideration will be given to how an annotation is featured, and to how it is generally used. Initially, the features of an annotation are listed as follows:

(1) Retention Period or Stock Period of Annotation

An annotation is attached when needed and removed when it becomes unnecessary, meaning that an annotation is not persistent. The information represented by an annotation is often a type of information stored over a shorter period rather than a type of information stored over a longer period.

(2) Location Information of Annotation

An annotation is attached to such a location in a destination document that a viewer is focusing on. Accordingly, the location of an annotation in a document indicates where the viewer is focusing on in the document, meaning that an annotation has locating information and performs a locating function. The term “location” is used to indicate an exact point in a document in some instances, and is used to indicate a certain area in a document in other instances.

(3) Usage of Annotation

While the information to be handled in a design specification and a manual is official or formal, the information to be handled with an annotation, such as a personal memorandum and the information shared among a plurality of members of a small group, is often private.

(4) Amount of Document Data of Annotation

An annotation is not used to handle a large amount of document data because of the nature of the annotation is that it is utilized for leaving a note, for example. In addition, because the use of an annotation is limited to the attachment of the annotation to a document, the annotation is not capable of handling a large amount of document data.

A person'ss attaching an annotation to a location in a document results in storing information at the location, and therefore, if the attached annotation is viewed by other persons, the information previously stored with the attached annotation will be transmitted to the other persons. Accordingly, attaching an annotation to a location in a document, at the same time, allows a plurality of persons viewing the same annotation to share the same information, resulting in the achievement of communication between the persons through the annotation. Even in a case where an annotation has been attached by a person to function as a private note and where the attached annotation, therefore, will not be viewed by other persons, the attached annotation can provide the person who attached the annotation with communication between himself at the time of the attaching and himself after the attaching. Because an annotation has several features described above, communication using annotations is considered as suitable for exchange of transitory and private information associated with a specific location in a document.

As one of the possible applications to utilize communication using annotations, an application to support an understanding of a program can be assumed. It is a usual approach for a person to view a source program when he attempts to understand a program. In the event of viewing the source program, new findings and/or unclear things are stored by attaching annotations to the source program. The attached annotations may be used to function as a private note, or may be used for communication including information exchanges, etc., by sharing the attached annotations with other viewers or with an author of the source program. It is important for a person who attempts to understand a program to communicate with other persons, not to only study the program alone. It is likely that hearing of other persons' opinions improves an understanding of a program, or that the communication with other persons detects new facts. Accordingly, communication with annotations is considered as useful in supporting an understanding of a program.

As is apparent from the above, an annotation, because of the aforementioned several features thereof, is considered as suitable for use in documenting and administering transitory information during a software development and maintenance. However, a conventional means of an annotation, made of paper, is so utilized as to be attached to a printed paper-document. It is difficult to document and administer transitory information during a software development and maintenance by using the paper-made annotation. Therefore, an annotation is preferably computerized.

Source programs, design specifications, manuals, documents, and drawings to be utilized in the stage of designing programs, etc., can be assumed as software-related documents. In order to computerize and administer transitory information during a software development and maintenance, annotations are preferably computerized together with these software-related documents.

In order to satisfy the need, software performing an annotation function that enables a user to attach electrical annotations to an electrical document, etc., has been marketed. The use of the software incorporating an annotation function allows persons concerned, to annotate documents shared among the persons concerned via a network, and to view and/or review the annotated documents, resulting in the achievement of communication with annotations between the persons concerned.

### BRIEF SUMMARY OF THE INVENTION

The use of conventional software for an annotation function allows one computer, which uses the same type of software for the annotation function that has been used by another computer for attaching an annotation to an electronic document, to display the electronic document with the attached annotation on the display screen and allows a user of the one computer to view the electronic document with the attached annotation. Therefore, the use of conventional software for an annotation function provides communication using annotations via a network only between a plurality of users of a plurality computers common in type of software for the annotation function that has been installed in the computers.

However, consider a first computer originally having no installed software for an annotation function, a second computer having an installed software for the annotation function, and a third computer having an installed software for attaching an annotation to an electronic document different in type from the software on the second computer. The second computer is incapable of displaying the electronic document with the attached annotation generated by the third computer and vice versa. Similarly, a user of the first computer is unable to view an electronic document with an attached annotation generated by either the second or third computer. As a result, persons concerned who respectively use computers, not common in type of installed software for an annotation function, fail to circulate or review the electronic document with the attached annotation, leading to incapability of achieving communication using annotations.

Therefore, an object of the present invention is to provide a method for causing a server to provide a plurality of client computers with annotation functions, thereby to allow users of the client computers to communicate with each other using annotations.

The present invention provides a method for causing a server to provide on-line and on-demand to a client computer, which is connected with the server via a network and which has a Web browser, an annotation function available to other client computers to thereby allow the client computer to communicate with the other client computers using annotations.

More specifically, the aforementioned method comprises a storing step of storing on the server, by the server, viewing information that allows a user of the client computer to view a document with an attached annotation on a screen of the client computer, and a transmitting step of transmitting, by the server in response to a request of the user to view the document, the viewing information to the client computer. The viewing information includes document information, annotation information, and a script.

The aforementioned document information represents the document in a format that allows the user to view the document by the Web browser, such that the document is defined so as to be classified into a plurality of objects which are capable of being designated individually.

The aforementioned annotation information represents the annotation in a format that allows the user to view the annotation by the Web browser. More particularly, the annotation information includes position information defining a position that the annotation is to be displayed by the Web browser with the annotation being attached to the document in association with a corresponding one of the plurality of objects.

The aforementioned script is to be executed by the client computer for allocating the annotation to the document.

In the present invention, the “object” may be interpreted to mean a minimum unit to be handled unitarily and independently as a unit that retains a specific property. The “annotation” may be achieved by displaying a particular comment or note at a particular position on a target document, by underlining, emphasizing, highlighting, coloring, or enclosing a particular portion of a target document, etc.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a diagram schematically illustrating a system according to an embodiment of the present invention;

FIG. 2 shows a screen layout of a client computer in operation in the system shown in FIG. 1, wherein a screen image is divided into four frames;

FIG. 3 shows an example of a tree-view in FIG. 2;

FIG. 4 shows examples of displaying modes of annotations in the system shown in FIG. 1;

FIG. 5 shows an example of a Java source program to be analyzed;

FIG. 6 shows an example of an XML repository corresponding to the Java source program shown in FIG. 5;

FIG. 7 illustrates an exemplary conceptual representation, for use in the configuration of the system shown in FIG. 1, of a process for generating the XML repository from the Java source program and then generating HTML for the tree-view and a source-view using XSLT;

FIG. 8 shows an example of HTML for the source-view shown in FIG. 7;

FIG. 9 illustrates an exemplary conceptual representation, for use in the system shown in FIG. 1, of a process performed at the respective times of attaching and displaying an annotation for storing on the server annotation data transmitted from the client computer in an XML format and then outputting to the client computer desired information that has been read out from the server, together with the HTML for the source-view;

FIG. 10 shows an exemplary conceptual representation of the structure of an HTML file created by sourceView.jsp, for use in the configuration of the system shown in FIG. 1;

FIG. 11 illustrates an exemplary application of the system shown in FIG. 1;

FIG. 12 is a flow chart illustrating a process in which a user of the client computer views an annotated document, whereby the client computer accesses the server in the system shown in FIG. 1;

FIG. 13 shows an example of a start page displayed, as a result of the implementation of a step c2 in FIG. 12, on a screen of the client computer by a browser thereof;

FIG. 14 shows an example of annotated documents displayed, as a result of the implementation of a step c4 indicated in FIG. 12, on the screen of the client computer by the browser thereof;

FIG. 15 shows variations of the displaying modes of annotations, by taking the screen image indicated in FIG. 14 as an example;

FIG. 16 shows a state in which all the annotations are displayed in an invisible mode, with the screen image indicated in FIG. 14 being taken as an example;

FIG. 17 is a flow chart illustrating a process in which the client computer accesses the server, whereby the user of the client computer attaches an annotation to a document displayed by the browser, in the system shown in FIG. 1;

FIG. 18A shows an example of a screen image in which a form that allows the user to attach annotations is displayed, as a result of the implementation of a step c11 indicated in FIG. 17, in a subframe of the screen image by the browser of the client computer;

FIG. 18B shows an example of a screen image in which data has been entered into the form for attaching annotations, as a result of the implementation of a step c12 indicated in FIG. 17, the form being displayed in the subframe of the screen image by the browser of the client computer;

FIG. 18C shows an example of a screen image in which a newly annotated document is displayed, as a result of the implementation of a step c15 indicated in FIG. 17, on the screen image by the browser of the client computer;

FIG. 19 is a flow chart illustrating a process in which the client computer accesses the server 10, whereby the user of the client computer retrieves annotations displayed by the browser in the system shown in FIG. 1;

FIG. 20A shows an example a form that allows the user to retrieve annotations displayed, as a result of the implementation of a step c21 indicated in FIG. 19, in the subframe of the screen image by the browser of the client computer;

FIG. 20B shows an example of a screen image in which search conditions has been entered into the form for retrieving annotations, as a result of the implementation of a step c22 indicated in FIG. 19, the form being displayed in the subframe of the screen image by the browser of the client computer;

FIG. 20C shows an example of a screen image in which search results are displayed, as a result of the implementation of a step c23 indicated in FIG. 19, in the subframe of the screen image by the browser of the client computer;

FIG. 21 shows a list of the respective names and representations of a plurality of components composing annotation data in the system shown in FIG. 1;

FIG. 22 shows a list of the respective component names and representations of a plurality of components composing a JX-model; and

FIG. 23 illustrates how one of a plurality of objects displayed on the screen to which a particular annotation is required to be attached is selected as a target object and how a position of the particular annotation to be attached is specified by the user in association with the selected target object.

### DETAILED DESCRIPTION OF THE INVENTION

Several presently preferred embodiments of the invention will be described in detail by reference to the drawings in which like numerals are used to indicate like elements throughout.

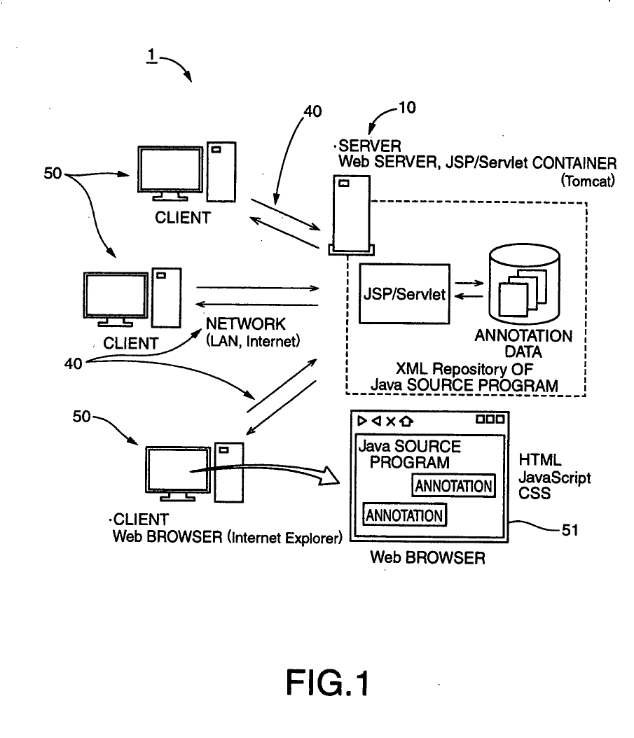

Referring now to FIG. 1, a system 1 constructed according to one embodiment of the present invention is shown. The system 1 includes a server 10, and at least one client computer 50 connected to the server 10 via a network 40. The network 40 may be a network such as the Internet using the public connection network or a LAN.

While the number of the at least one client computer 50 used in the system 1 may be one or multiple, one client computer 50 will represent the at least one client computer 50 for the sake of simplicity. The client computer 50 is so configured as to be communicable with the server 10 via the network 40. The client computer 50 includes a display device (not shown) for displaying data, such as a CRT or an LCD, and an input device (not shown) for inputting data, such as a keyboard or a mouse.

The client computer 50 employs a popular Web browser (e.g., Netscape Navigator or Microsoft Internet Explorer), and is adapted to permit entry of communication data from the input device and presentation of a screen image on a screen of the display device. Accordingly, a connection between the client computer 50 and the server 10 via the network 40 would allow a user of the client computer 50 to access and utilize a Web site (for sending Web pages) built on the server 10.

Next, the operation of the system 1 according to the present embodiment of the present invention will be described sequentially in conjunction with a viewing function that allows the user to view an annotated document, an attaching function that allows the user to attach annotations to a document, and a retrieving function that allows the user to retrieve annotations attached to a document.

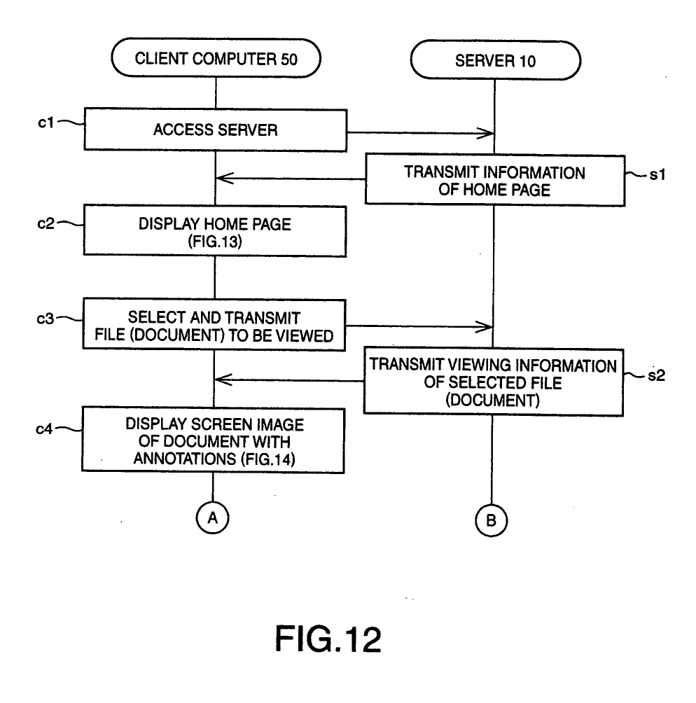

Initially, the operation of the system 1 will be described with respect to the above viewing function in reference to FIG. 12. In FIG. 12, the process in which the client computer 50 accesses the server 10, whereby the user of the client computer 50 views an annotated document is illustrated in a flow chart.

The above process begins at a step c1 indicated in FIG. 12 in which the user of the client computer 50 issues a request for establishing a connection to the server 10 using the Web browser of the client computer 50. Specifically, the user issues the request at the client computer 10 by entering an address (a uniform resource locator or “URL”) of the Web site of the server 10 into the client computer 50, for example.

In response to the request, in a step s1 indicated in FIG. 12, information (data) representing a start page (referred to also as “home page” or “entry page”) retained by the server 10 is transmitted therefrom to the client computer 50.

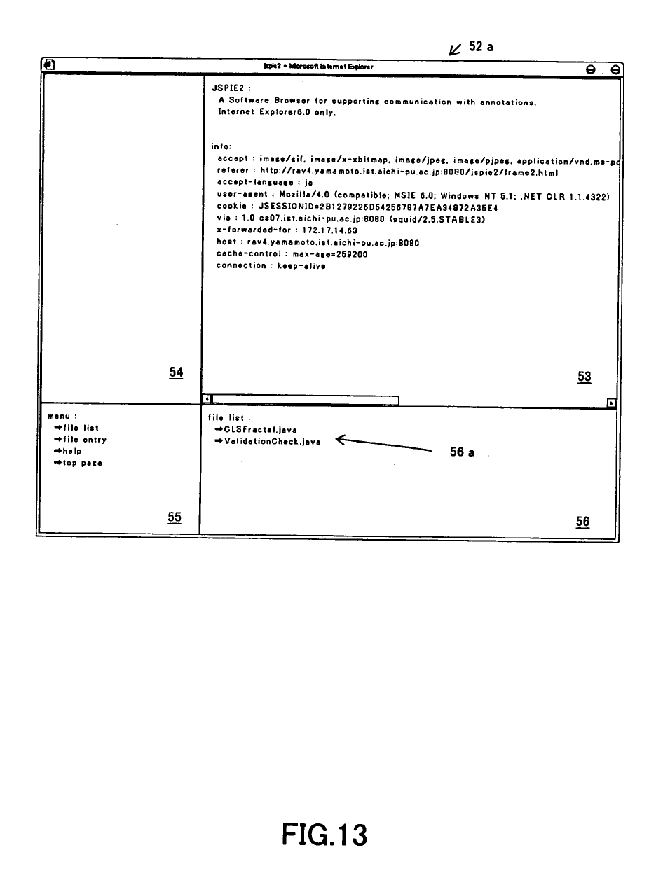

Upon transmission, in a step c2 indicated in FIG. 12, a start page 52a such as shown in FIG. 13 is displayed on the display device by the Web browser. The start page 52a is divided into four frames, namely, a source-view frame 53, a tree-view frame 54, a menu frame 55, and a subframe 56. In the subframe 56, the names of files (documents) 56a viewable to the user are displayed in a list format.

Thereafter, in a step c3 indicated in FIG. 12, the user of the client computer 50 selects the name of a file (document) that the user wishes to view, from the names of files 56a displayed in the subframe 56 (i.e., for example, clicks the mouse with a pointer thereof being located at the selected name on the screen) whereby this request from the user is sent to the server 10.

Subsequently, in a step s2 indicated in FIG. 12, the server 10 selects, upon receiving the request previously handled by the step c3, one of sets of viewing information stored on the server 10 which corresponds to the selected name, and then transmits the selected set of viewing information to the client computer 50. The set of viewing information includes: a) document information representing a selected file (document) in a format viewable in the Web browser (e.g., a Hyper-Text Mark-up Language (HTML) file); b) annotation information representing annotations in a format viewable in the Web browser (e.g., an HTML file); and c) a script for allocating the annotations to the file (document) (e.g., a JavaScript).

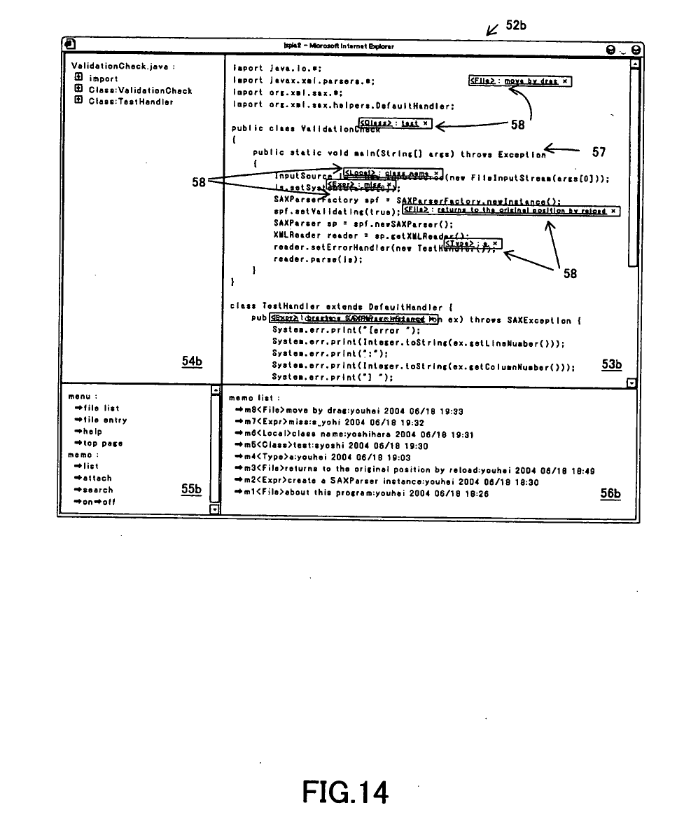

Upon transmission of the selected set of viewing information, in a step c4 indicated in FIG. 12, a screen image 52b such as shown in FIG. 14 is displayed on the screen of the display device by the Web browser at the client computer 50.

In the source-view frame 53b of the screen image 52b, a document 57 is displayed along with annotations 58 attached to the document 57. In a tree-view frame 54b, the structure of the document 57 is displayed in a tree structure. In a subframe 56b, a list of annotations that have been attached to the document 57 is displayed.

The user can change a displaying mode of the respective annotations 58 displayed in the source-view frame 53b. In an embodiment of the present invention, the displaying mode of annotation is changeable into one of five modes, namely, a normal mode, a full-content mode in which all the contents of a target annotation are visible, a reducing mode, a highlighting mode, and an invisible mode in which a target annotation is invisible.

In the highlighting mode, a specified portion of a document on the screen is colored with an arbitrary color with an arbitrary transparency, allowing viewers (readers) of the document to visually distinguish the specified portion from surrounding portions thereof as if a specified portion of a paper were marked with a highlighter in a conventional manner. Thus, the highlighting mode performs the function of conveying a certain type of information to the viewers.

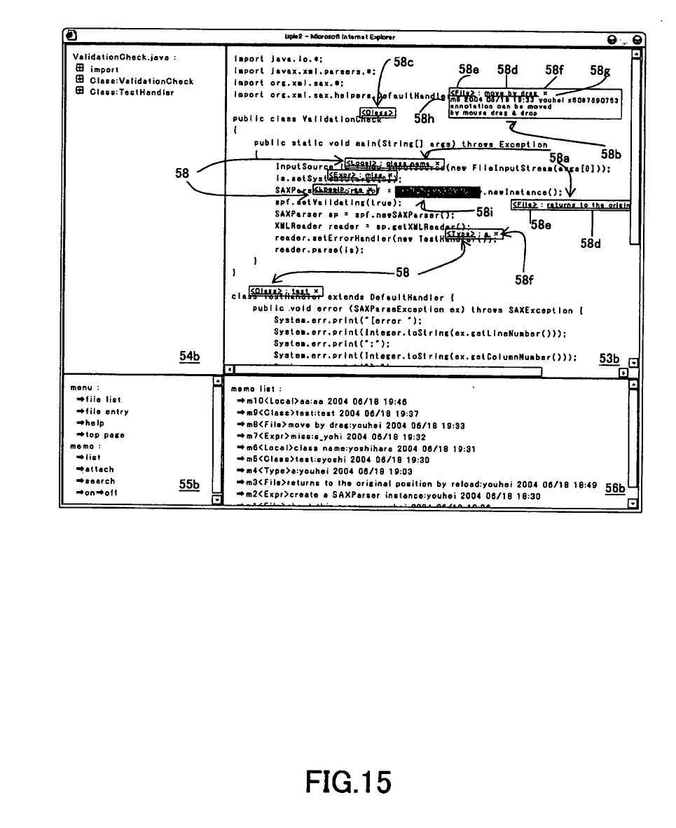

In FIG. 15, an example of a set of variations of the displaying modes of annotation is illustrated. Annotation 58a which are displayed in the source-view frame 53b in the normal mode, each indicate a title section 58d, an object section 58e, and an “x” section 58f. An annotation 58b, which is displayed in the full-content mode, indicates the title section 58d, the object section 58e, the “x” section 58f, an author's name 58g, and a text body 58h. An annotation 58c, which is displayed in the reducing mode, indicates the object section 58e only. An annotation 58i is displayed in the highlighting mode.

Changes in the displaying mode of each of the annotations 58 are caused by a user operation through the input device at the client computer 50 (for instance, the user clicking). There will be described in more detail below changes in the displaying mode by referring to FIG. 15.

First, the change in the displaying mode from the normal mode to the full-content mode is now described. When the user clicks the mouse at the title section 58d of a selected annotation displayed in the normal mode, the displaying mode of annotation is changes to the full-content mode like that of the annotation 58b. It is added that, if the user clicks the mouse on the title section 58d of a selected annotation displayed in the full-content mode, then the displaying mode of the annotation returns to the normal mode.

Second, the change in the displaying mode from the normal mode or the full-content mode to the reducing mode is now described. When the user clicks the mouse at the object section 58e of a selected annotation displayed in the normal mode or the full-content mode, the displaying mode of annotation is changed to the reducing mode like that of the annotation 58c. It is added that, if the user clicks the mouse on the object section 58e of a selected annotation in the reducing mode, then the displaying mode of the annotation is changed to the full-content mode.

Additionally, the change in the displaying mode from a visible mode, such as the normal mode, the full-content mode, or the reducing mode to the invisible mode will be described below. When the user clicks the mouse at the “x” section 58f of a selected annotation displayed in the normal mode or the full-content mode, the displaying mode of annotation is changed to the invisible mode. It is added that, for causing the client computer 50 to change the displaying mode of annotation from the invisible one to the visible one, the user is required to select a “memo:on” portion displayed in the menu frame 55b (i.e., for example, click the mouse with the pointer thereof being located at the portion where the “memo:on” portion has been displayed).

While the changes in the displaying modes of the annotations 58 have been discussed above in reference to FIG. 15, there will be described below the case where, at one time for all the annotations 58 attached to the document 57, the displaying mode of each of the annotations 58 is changed from a different one (i.e., from the visible mode into the invisible mode, or conversely from the invisible mode into the visible mode).

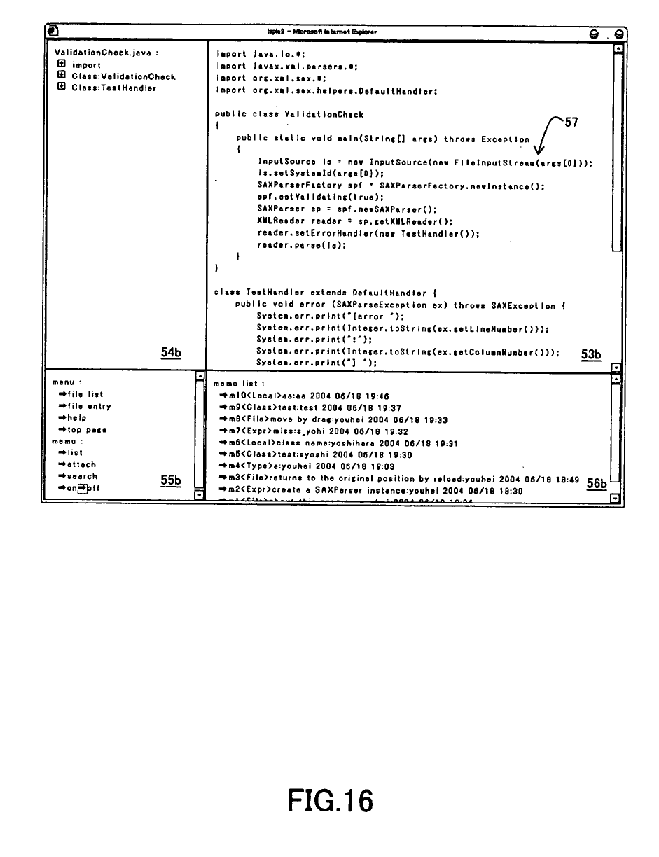

In the above case, once the user selects a “memo:off” portion in the menu frame 55b indicated in FIG. 15 (i.e., for example, the user clicks the mouse with the pointer thereof being located at the portion where “memo:off” is displayed), the displaying mode for all the annotations 58 attached to the document 57 is changed to the invisible mode, as shown in FIG. 16. If the user, this time, selects the “memo:on” portion in the invisible modes, all the annotations 58 become to be displayed. It is added that, depending on the user dragging, each annotation 58 can be moved to a different location and stayed there temporarily. Upon reloaded, the moved annotation 58 is moved back to an original location.

With the reference to FIG. 12, there has been described in the process in which the client computer 50 accesses the server 10, whereby the user of the client computer 50 views an annotated document displayed by the Web browser. A portion of the server 10, which implements the step s1, functions as means for transmitting information for specifying a target document, and a portion of the server 10, which implements the step s2, functions as means for transmitting viewing information. These two means together constitute means for enabling annotations to be viewed, such that a mere utilization of the Web browser by the client computer 50, originally having no installed software for an annotation function, allows the user of the client computer 50 to view a document together with attached annotations.

The operation of the system 1, although it has been described above with respect to the viewing function, will be described below with respect to the attaching function, namely, a function that allows the user to attach annotations.

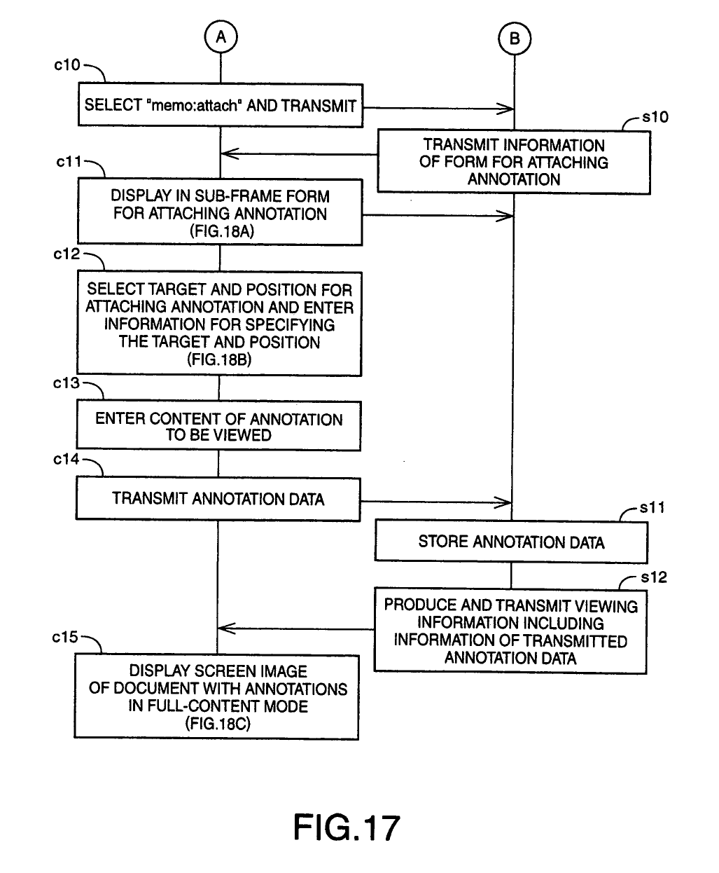

FIG. 17 shows a process performed in a state that the document 57 (see FIG. 14) has been displayed on the screen of the client computer 50 by the Web browser thereof, as a result of the implementation of the step c4 indicated in FIG. 12. The process is performed such that the client computer 50 accesses the server 10, whereby the user of the client computer 50 attaches the annotations 58 to the document 57 displayed by the Web browser. This process is initialed at a step c10 indicated in FIG. 17 in which the user of the client computer 50 selects a “memo:attach” portion in the menu frame 55b (for example, the user clicks the mouse with the pointer thereof being located at the position where the “memo:attach” portion is displayed), whereby the request is sent to the server 10.

Next, in a step s10 in FIG. 17, the server 10, upon receiving the request handled in the step c10, transmits information (data) of an attach form for allowing the user to attach annotations, to the client computer 50.

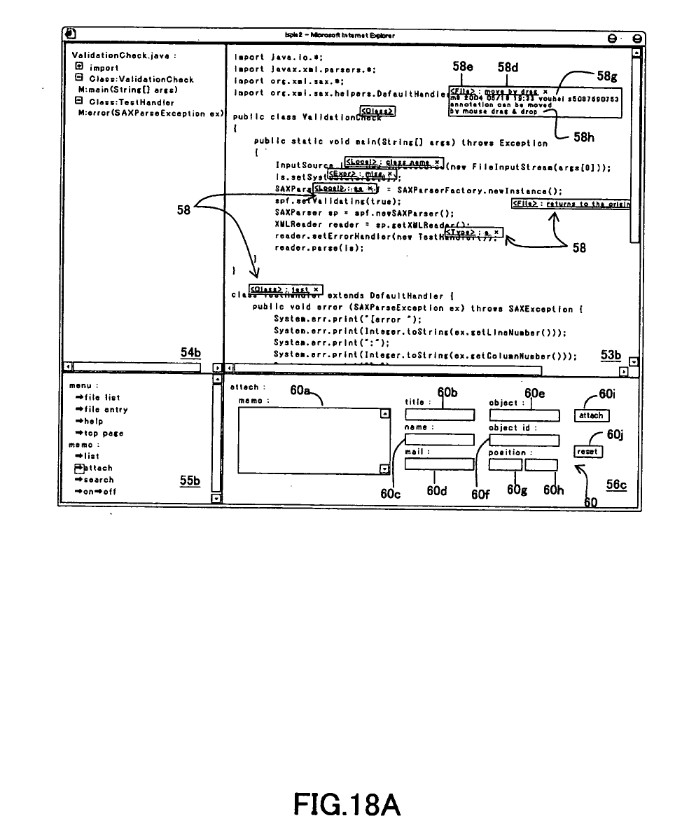

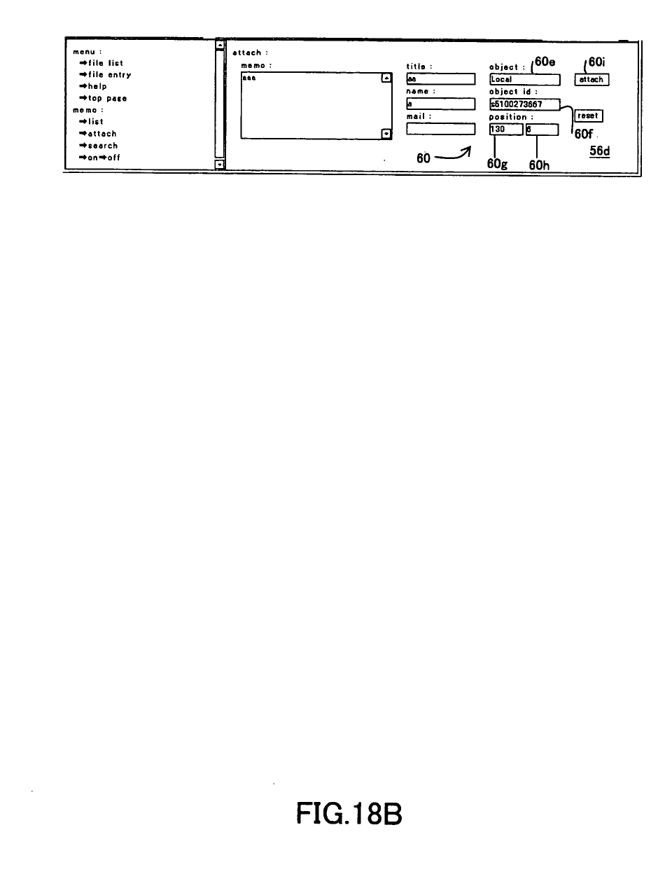

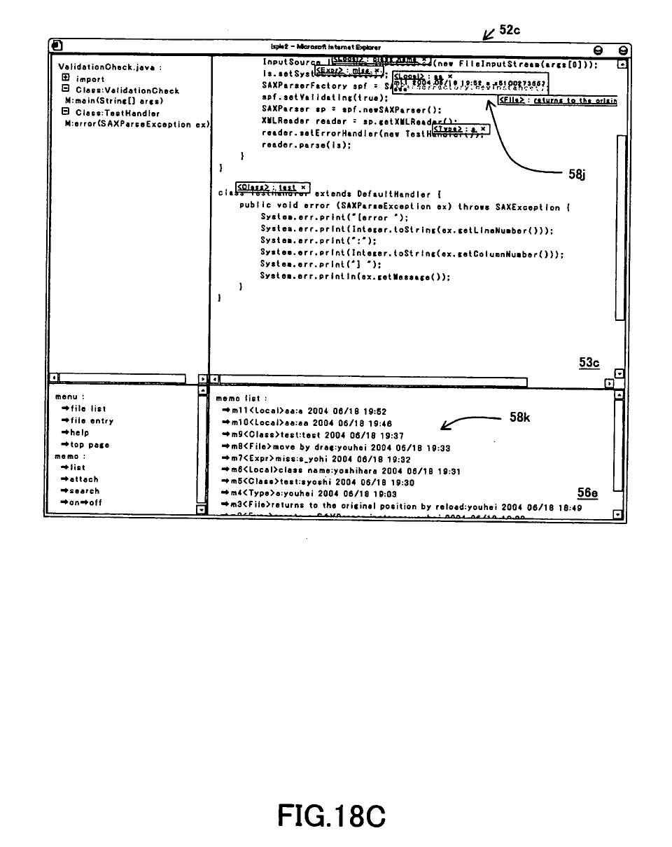

Once the information is transmitted, in a step c11 indicated in FIG. 17, an attach form 60 for allowing the user to attach annotations is displayed in the subframe 56c by the Web browser of the client computer 50, as shown in FIG. 18A.

The attach form 60 contains: a “memo” field 60a; a “title” field 60b; a “name” field 60c; a “mail” field 60d; an “object” filed 60e; an “object id” field 60f, “position” fields 60g and 60h; an “attach” button 60i; and a “reset” button 60j.

The information entered into the “memo” field 60a by the user is displayed in the text body 58h of the corresponding annotation 58. The information entered into the “title” field 60b is displayed in the title section 58d of the corresponding annotation 58. The information entered into the “name” field 60c is displayed in the “author'ss name” field 58g of the corresponding annotation 58. The information entered into the “object” field 60e is displayed in the object section 58e of the corresponding annotation 58.

Next, in a step c12 in FIG. 17, the user selects in the document 57 displayed in the source-view frame 53b shown in FIG. 18A, a target object at which he wishes to attach a specific annotation to the document 57. For example, the user clicks the mouse with the pointer thereof being located at the position in the document 57 at which the user wishes to attach a specific annotation. Consequently, as shown in FIG. 18B, data of the target object selected at the step c12 by the user who wishes to attach a specific annotation, is inputted into the “object” field 60e, the “object id” field 60f, and the “position” fields 60g and 60h within the attach form in the subframe 56d, respectively.

Described more specifically, in the present embodiment of the present invention, the document 57 is composed by a plurality of objects which are displayed on the screen, such that a single display area is assigned to each of the objects (for example, a single minimum area covering the entirety of each object to be displayed). The single display area corresponds to a single object only. A typical example of the shape of the display area is a rectangle enclosed by four sides, two of which extend in a vertical direction of the screen, and the remainders of which extend in a horizontal direction of the screen.

The display areas respectively assigned to the objects do not have respective sizes, all of which are set commonly to all of the objects, but have respective sizes set individually in a per object basis. To be more specific, the display area of each object is set in a per object basis, so as to have its size dependent on the size of the object displayed on the screen (for example, equal to the size of the object displayed on the screen).

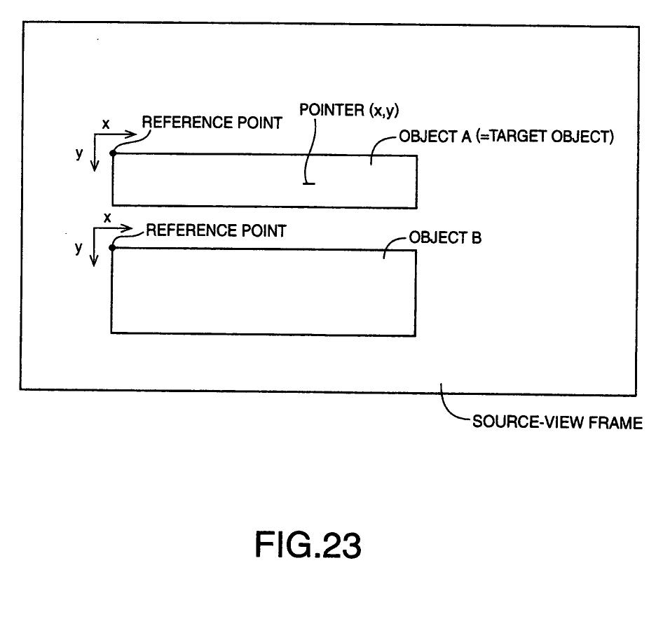

As shown in FIG. 23, once the user clicks the mouse on a target object, namely, one of the plurality of objects which the user wishes to annotate, the target object is selected from the plurality of objects based upon the position of the mouse pointer on the screen at the time of the user clicking. One of the plurality of objects that has the displaying area within which the mouse pointer is located is selected as a target object. The selected target-object is then reflected in the “object” field 60e, and the “id” of the selected target-object is reflected in the “object id” field 60f.

As shown in FIG. 23, a reference point has been previously assigned to the display area of the selected target-object. When the user clicks the mouse for selecting a target object, the position of the mouse pointer, namely, the position at which the user wishes to annotate (for example, a start position of the representation of an annotation to be attached) is detected relative to the reference point in the x-direction (horizontal direction) and the y-direction (vertical direction), respectively. In other words, the reference point functions as the origin of a relative coordinate system referred to in defining the position of an attached annotation to be displayed. Accordingly, the attached annotation is moved on the screen according to a movement of the reference point. As a result, in the case where a layout of a document displayed on the screen is modified, the position of the annotation attached to the document is automatically modified according to the modification of the layout of the document.

Into the “position” filed 60g, there is entered the relative coordinates of a required position by the user to be annotated in a document in the x-direction relatively to the reference point, while, into the “position” field 60h, there is entered the relative coordinates of a required position by the user to be annotated in a document in the y-direction relatively to the reference point.

Having specified the position at which the user wishes to annotate in a document, as in a manner described above, the user enters, in a step c13 indicated in FIG. 17, information necessary for specifying the text body, the title, and the author required by the user to be displayed on the annotation(when the annotation is displayed in the highlighting mode, it is also necessary to specify the color) into the attach form 60 through the input device of the client computer 50 (for example, the keyboard or the mouse).

Next, in a step c14 shown in FIG. 17, the user selects the “attach” button 60i in the attach form 60 (for example, the user clicks the mouse with the pointer thereof being located at the position where the “attach” button 60i has been displayed), with the result that the annotation data previously entered into the attach form 60 is transmitted to the server 10.

Further, in a step s11 shown in FIG. 17, once the transmission of the annotation data to the server 10 is completed, the annotation data is stored on the server 10 in an extensible Markup Language (XML) format, for example.

Subsequently, in a step s12 shown in FIG. 17, required data is read from the annotation data stored on the server 10, and annotation information representing the annotation in a format viewable in the Web browser (for example, in an HTML format) is generated by the use of an XML parser adapted to implement a Document Object Model (DOM), for example.

In the step s12, further, the generated annotation information and document information representing a document in a format viewable in the Web browser previously installed into the server 10 (for example, in an HTML format), are combined into viewing information including annotation information related to a newly attached annotation. The viewing information includes the annotation information, the document information, and a script for allocating the annotation onto the document (for example, a JavaScript). The viewing information including the annotation information related to the newly attached annotation is transmitted from the server 10 to the client computer 50.

After the transmission, in a step c15 shown in FIG. 17, a screen image 52c shown in FIG. 18C is displayed on the screen of the client computer 50 by the Web browser 51 thereof. Reference numeral “58j” in the source-view frame 53c denotes a newly attached annotation. The annotation 58j is displayed in the full-content mode. In the subframe 56e of the screen image 52c, a file name 58k of the annotation 58j,is so displayed as to be added to the list of files viewable to the user.

There has been described above in reference to FIG. 17 a process in which the client computer 50 accesses the server 10, whereby the user of the client computer 50 attaches an annotation to a document displayed by the Web browser. A portion of the server 10 which implements the steps s10 and s11 functions as means for storing annotation data, and a portion of the server 10 which implements the step s12 functions as means for generating viewing information. These two means together constitute means for enabling attaching annotations, such that a mere utilization of the Web browser by the client computer 50 originally having no installed software for an annotation function, allows the user of the client computer 50 to attach annotations to a document.

Next, there will be described the operation of the system 1 with respect to a retrieval function that allows the user to retrieve a designated one of the annotations attached to a document.

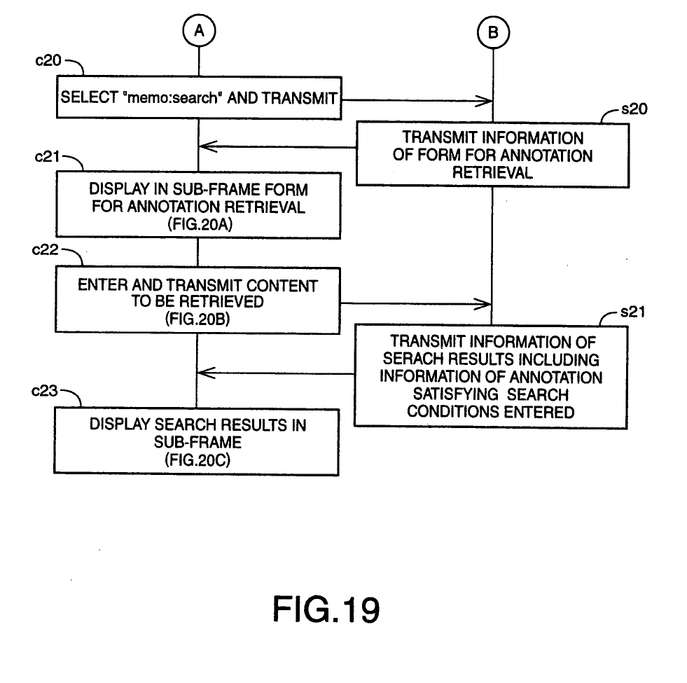

FIG. 19 shows a process performed in a state that the document 57 (see FIG. 14) has been displayed on the screen of the client computer 50 by the Web browser thereof, as a result of the implementation of the step c4 indicated in FIG. 12. The process is performed such that the client computer 50 accesses the server 10, whereby the user of the client computer 50 retrieves on the annotations 58 displayed by the Web browser.

The process is initiated at step c20 indicated in FIG. 19 in which the user of the client computer 50 selects a “memo:search” portion in the menu frame 55b (for example, the user clicks the mouse with the pointer thereof being located at the position where the “memo:search” portion is displayed), whereby the request is sent to the server 10.

Next, in a step s20 in FIG. 19, the server 10, upon receiving the request handled in the step c20, transmits information (data) of a retrieval form that allows the user to retrieve a requested annotation, to the client computer 50.

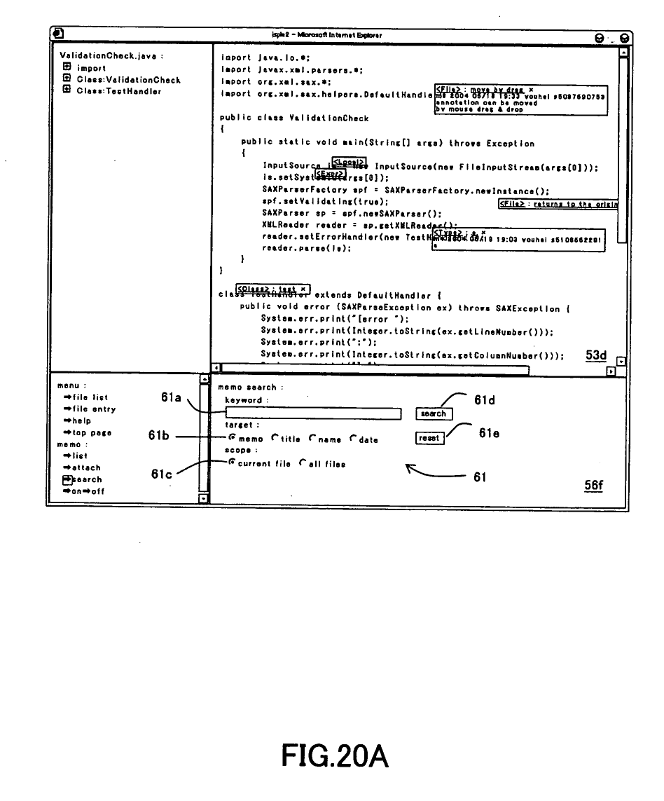

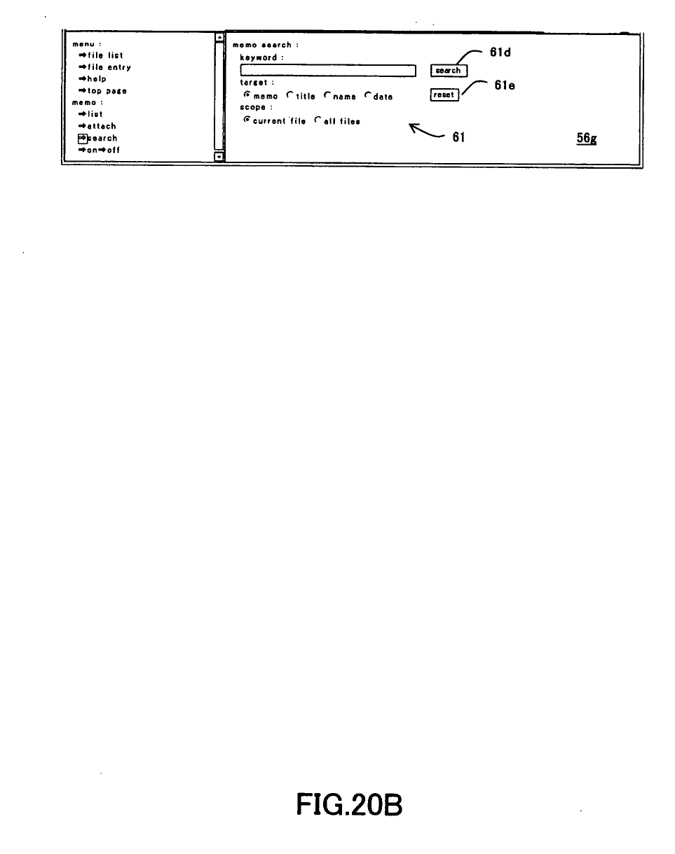

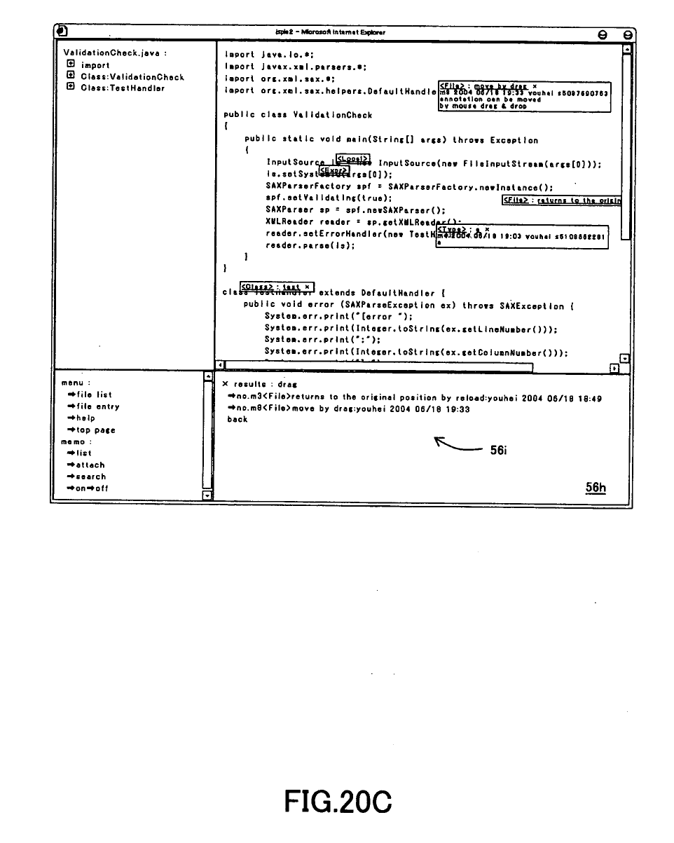

After the transmission, in a step c21 indicated in FIG. 19, a retrieval form 61 that allows the user to retrieve a required annotation is displayed in the subframe 56f by the Web browser of the client computer 50, as shown in FIG. 20A.

The retrieval form 61 contains: a “keyword” field 61a; a “target” field 61b; a “scope” field 61c; a “search” button 61d; and a “reset” button 61e, all of which are displayed in the retrieval form 61. The “keyword” field 61a is a field into which a word to be retrieved is entered, and the “target” field 61b is a field into which a target of the retrieval is entered. For example, when the target of the retrieval is the bodies of annotations, the user is required to select a “memo” portion. In the “scope” field 61c, the user is required to select a “current file” portion if the user wishes to conduct an annotation retrieval on annotations of the file that is currently displayed in the source-view frame 53d, while the user is required to select a “all files” portion if the user wishes to conduct an annotation retrieval on annotations of all files.

Next, in a step c22 shown in FIG. 19, the user enters search conditions into the retrieval form 61 in the subframe 56g indicated in FIG. 20B through the input device of the client computer 50 (for example, the keyboard or the mouse).

Upon entry, the user selects the “search” button 61d (for example, the user clicks the mouse with the pointer thereof being located at the position where the “search” button 61d has been displayed), with the result that information of the search conditions previously entered into the retrieval form 61 for an annotation retrieval (i.e., search conditions) is transmitted from the client computer 50 to the server 10.

Once the transmission is completed, in a step s21 shown in FIG. 19, the server 10, upon receiving the request handled in the step c22, transmits part of annotation information retained on the server 10 that represents annotations satisfying the search conditions, to the client computer 50.

After the transmission, in a step c23 shown in FIG. 19, a list 56i of the annotations satisfying the search conditions is displayed in a subframe 56h by the Web browser of the client computer 50, as shown in FIG. 20C. The list 56i includes links to the respective annotations satisfying the search conditions.

There has been described above in reference to FIG. 19 the process in which the client computer 50, once accessed the server 10, performs retrieval on the annotations 58 displayed by the Web browser. A portion of the server 10 that implements the steps s20 and s21 functions as means for retrieving annotations, such that a mere utilization of the Web browser by the client computer 50 originally having no installed software for an annotation function, allows the user of the client computer 50 to retrieve annotations attached to a document.

For providing the annotation functions described above to the client computer 50, browser software is installed on the server 10. One example of the browser software is a tool for supporting software development in terms of communication, called “JSPIE2.” This browser software “JSPIE2” (hereinafter, referred to simply as “JSPIE2”) will be described below in more detail.

In software development, communication such as the exchange or the sharing of information plays an important role. To this end, the JSPIE2 has been so developed as to be directed to communication using annotations, which is a kind of communication between software development engineers on the same project. The JSPIE2 is provided as browser software that, because of a function thereof that permits electronic annotations to be attached to a source program, enables on-line communication for a source program. In the case of this JSPIE2, the source program is one example of the aforementioned document 57.

Programming language of a source program to be supported in development by the JSPIE2 includes, but not limited to, Java, wherein the source program is viewed by a plurality of persons using the Web browser. Because the source program is made up of a plurality of objects in hierarchical form, the JSPIE2 allows annotations to be attached to the source program in association with specified ones of the plurality of objects of the source program. The source program with attached annotations can be viewed along with the attached annotations by a plurality of persons via the network 40.

Referring again to FIG. 1, as described above, the configuration of the system 1 is illustrated. The JSPIE2 is a Web application. After installation on the server 10, the JSPIE2 is used so that it can be accessed by the client computer 50 using the Web browser. The JSPIE2, therefore, can be utilized via the network 40 (e.g., a LAN or the Internet). In addition, information is shared among a plurality of client computers 50 via the server 10.

The server 10 uses “Tomcat” which is well known for “Jakarta Project.” The server 10 is configured to implement Java Server Pages (JSP)/Servlet. JSP includes any of a number of Java technologies that are directed to servers and that enable the dynamic generation of Web pages. “Servlet” is a technology for implementing software components that perform processing on a Web server upon request of a client (Web browser). Dynamic HTML (DHTML) (e.g., HTML, JavaScript, Cascading Style Sheet (CSS), or any other technology for adding interactivity to Web pages), which is used for allowing output of the server 10 to the client computer 50, provides the annotation functions at the client computer 50.

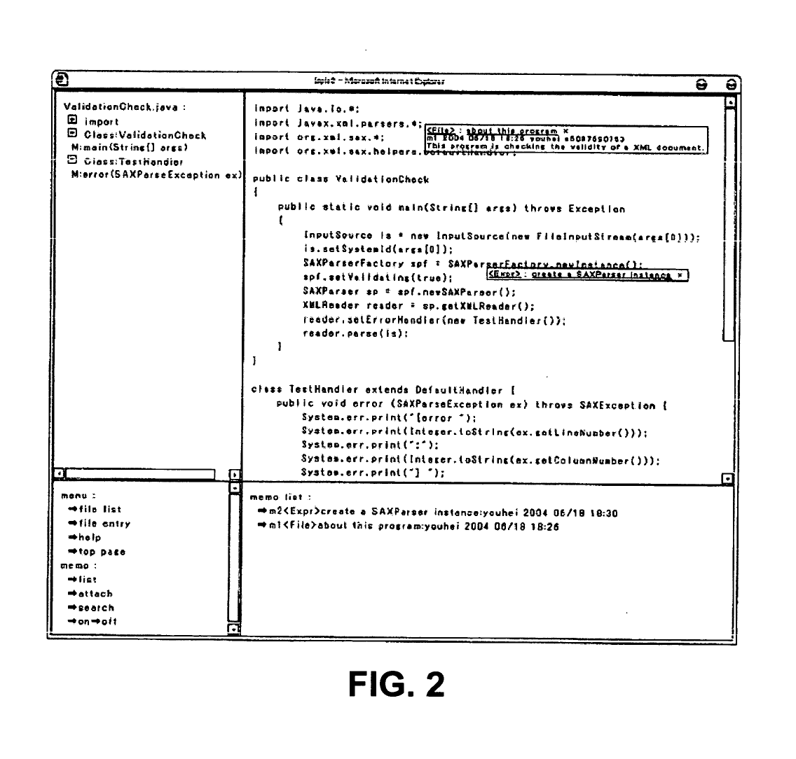

As described above, and as shown in FIG. 2, the screen image displayed as a result of the implementation of the JSPIE2 at the client computer 50 is divided into four frames. In the source-view frame (at the upper right-hand side of the screen image), a source program and attached annotations are displayed, and in the tree-view frame (at the upper left-hand side of the screen image), the tree-view is displayed on a per file basis. In the menu-frame (at the lower left-hand side of the screen image) and the sub-frame (at the lower right-hand side of the screen image), respectively, the JSPIE2 allows the user to conduct various manipulations.

The JSPIE2 contains the following five basic functions.

(1) Tree-View Function

The implementation of the JSPIE2 causes the client computer 50 to display the structure of a Java source program in the tree-view frame in a tree structure format. In the displayed tree, Classes or Interfaces correspond to Nodes, while Fields, Methods, and Constructors, respectively, correspond to Leaves. The tree displayed in a foldable manner acts in a fashion as with “Explorer” of “Microsoft Windows.”

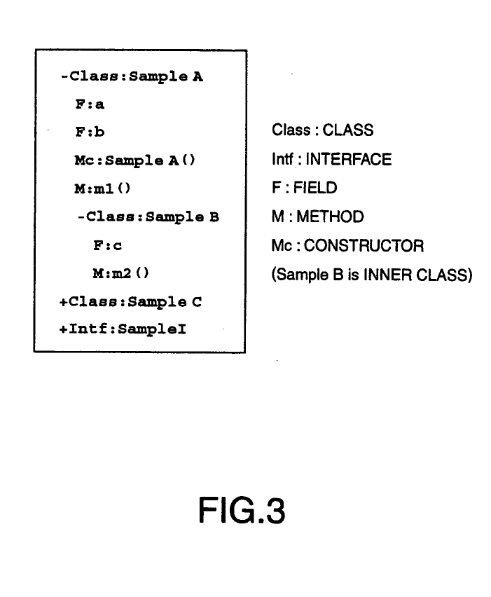

FIG. 3 shows one example of the tree-view. The tree-view of FIG. 3 represents that the file being viewed contains Class “Sample A,” Class “Sample C,” and Interface “Sample I,” with these components serving as objects, respectively. In this tree-view, Class “Sample A” is displayed in an expanded state, so as to indicate that Class “Sample A” includes therein Fields “a” and “b,” Constructor “Sample A( ),” Method “m1 ( ),” and Inner Class “Sample B.”

(2) Source-View Function

Once any one of the titles of a plurality of objects displayed in the tree-view frame has been selected, a link is utilized that has been created between the selected title and one of the objects that corresponds to the selected title. As a result, one of the objects corresponding to the selected title is referred to and displayed in the source-view frame.

(3) Function of Attaching Annotations

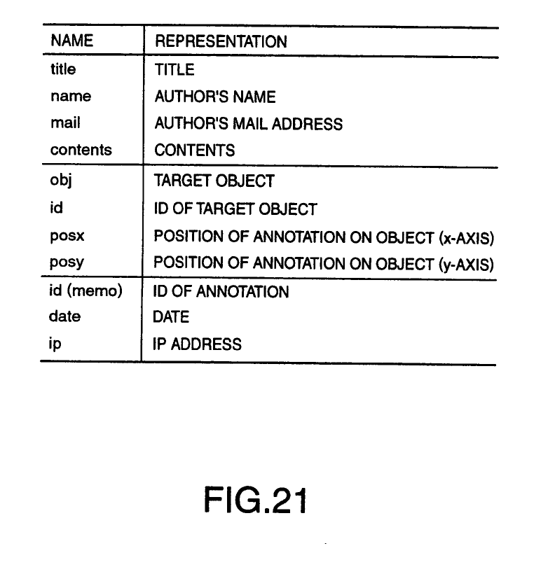

Once the user clicks on an arbitrary position in a source program, a currently targeted one of a plurality of objects (hereinafter, referred to as a “target object”) is selected, and a position at which a specified annotation is to be attached to the selected target object is determined. As a result, an annotation in a text format is attached to the source program. FIG. 21 shows information that can be retained by an annotation.

The entry of data into an “obj” field, an “id” field, a “posx” field, and a “posy” field is performed by the user clicking the mouse. Data to be entered into the “posx” field is the relative coordinates indicative of a position at which the annotation is to be attached in the x-axis direction, relative to the aforementioned reference point. Similarly, data to be entered into the “posy” field is the relative coordinates indicative of a position at which the annotation is to be attached, in the y-axis direction, relative to the aforementioned reference point.

The entry of data into the “title” field, the “name” field, the “mail” filed, and the “contents” field is performed by the user keyboard entry. More specifically, the entry is performed by the user who enters data with the keyboard into the form in an HTML format for allowing the user to attaching annotations, wherein the form, after sent from the server 10 to the client computer 50, is displayed in the sub-frame.

The entry of data into the “id (memo)” field, the “date” field, and the “ip” field is automated by the server 10.

(4) Function of Displaying Annotations

An annotation attached in the above manner is displayed at a designated position on a target object in a source program. As described above, the displaying mode of an annotation can be varied into one of the four modes depending upon the situation of the annotation. These variations of the displaying mode, although they have been described above, will be described complementarily later.

(5) Function of Retrieving Annotations

A specified annotation can be retrieved from a plurality of annotations that have been already attached to a target document. In the retrieval session, first, a retrieval form in an HTML format that allows the user to retrieve annotations, which form has been sent from the server 10 to the client computer 50, is displayed in the sub-frame. The user enters the following information into the retrieval form that is displayed: search terms (keywords) for retrieving a requested annotation; a type of the requested annotation; and the scope within which the retrieval is to be conducted (e.g., whether the retrieval is to be conducted within a file that is currently viewed or within all files). Upon entry, the retrieval is performed, and then, a list of annotations satisfying the retrieval conditions is displayed in the sub-frame. Each of the titles of the annotations appearing in the list includes a link to an object specified by the each title.

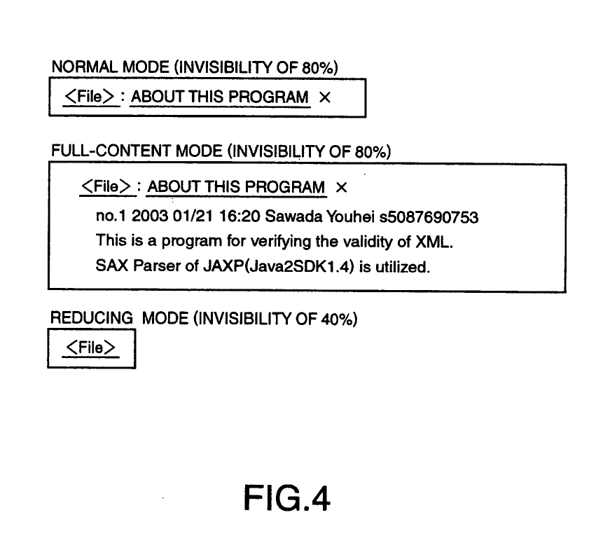

The details of the displaying modes of annotations will be described complementarily below. As described above, the displaying mode of an annotation can be changed into one of four modes, namely, the normal mode, the full-content mode, the reducing mode, and the invisible mode, wherein a change of the displaying mode occurs depending upon the user activities such as clicking. FIG. 4 shows examples of variations of the displaying modes of annotations. The user dragging would cause an annotation to move from an original position to a different position and stay there temporarily. Nevertheless, the previously moved annotation, upon reloading, returns to the original position.

(a) Normal Mode

When an annotation is displayed in the normal mode, an annotated object and the title thereof are displayed. The displaying mode of an annotation, whatever the current mode is, returns to this normal mode, upon reloading.

(b) Full-Content Mode

The full-content mode is one to which the displaying mode of a target annotation is shifted from any of the other modes when: at the time that the user clicks on the title of the target annotation, resulting in the display of the contents of the target annotation; at the time that the user, immediately after attaching an annotation, selects one of annotations appearing in the list of annotations as a target annotation; or at the time that the user selects a target annotation in the search results. The contents displayed in this full-content mode include: the identification of a target annotation; the date; the author; the identification of the target object; and the body of the target annotation.

(c) Reducing Mode

The reducing mode is one that the displaying mode of a target annotation is intended to take, once the user clicks on the name of the target object. This reducing mode is utilized for identifying the object that the target annotation has been attached to. When a target annotation is displayed in this reducing mode, only the name of the object is displayed, so that the invisibility of the target annotation is decreased from b 40% to 80%. When a target annotation is displayed in this reducing mode, there may occur over a period of time a temporal change in the color of a target object on a source program, for example, into orange, so that the target object is visually emphasized.

(d) Invisible Mode

The invisible mode is one that the displaying mode of a target annotation is intended to take upon the user clicking on the “x” section of the target annotation. The displaying mode of a target annotation returns from this invisible mode either at the time that the user clicks on the “memo:on” to be selected for the display of all the annotations; at the time that the user selects the target annotation from the list of annotations; or at the time that the target annotation is reloaded.

There will be described the JSPIE2 below by means of the activities that are achieved as a result of the implementation of the JSPIE2 by the client computer 50, namely, by means of the basic flow of the processing in which the JSPIE2 is employed.

Once the JSPIE2 is opened at the client computer 50, a file list (i.e., a list of viewable files) is displayed in the sub-frame. The user selects from the list the file that he wishes to view.

In the source-view frame, a source program with annotations is displayed. During the display, a list of annotations attached to the displayed source program is displayed, so that the user, if he designates a specific annotation in the list, can view the specific annotation. In addition, in the tree-view frame, the source program as constructed by a plurality of objects in a hierarchical structure is displayed in a tree structure form. The user, if he designates a specific object in the displayed tree, can view the specific object.

The user who attempts to attach an annotation to a document, prior to the attaching action, selects an “attach” portion in a plurality of menu options displayed in the menu frame. In response, an attach form that allows the user to attach annotations to a displayed document is displayed in the subframe. The user, thereafter, clicks at an object that the user wishes to annotate on the source program displayed in the source-view frame, whereby a target object is determined. The user further enters the content of an annotation that the user wishes to attach, into the attach form, and subsequently, the content of the form is transmitted from the client computer 50 to the server 10.

Upon completion of the user action for attaching a new annotation, the representation of the source-view is updated and, as a result, the new annotation just attached is displayed in the source-view frame in the aforementioned full-content mode.

A JX-model is utilized in implementing the aforementioned JSPIE2 that is well-known by the article titled “Implementation of Generic Fine-grained Software Repository Using XML,” co-authored by Hajime Yoshida, Shinichirou Yamamoto, and Kiyoshi Agusa, for the 2002 Symposium of Information Processing Association, (August 2002), pp. 83-90. The utilization of the JX-model is aimed at classifying a Java source program into a plurality of given objects, thereby allowing the user to attach an annotation to any one of these objects on a per object basis. The JX-model refers to a model of an XML repository of a Java source program.

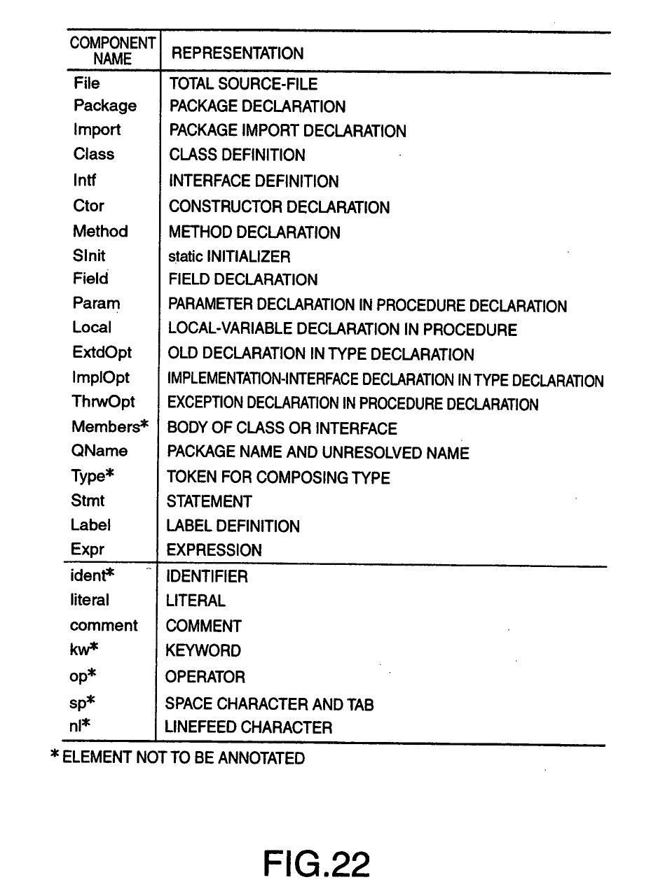

The JX-model allows the modeling of a source program written in Java (e.g., Java2, Version 1.4) by means of twenty types of non-terminal elements and seven types of terminal elements. The term “terminal element” means an element that does not have a JX-model element as a child node. FIG. 22 shows a list of these elements. In FIG. 22, the elements bridging from a “File” element to an “Expr” element fall within the non-terminal elements, while the elements following an “ident” element fall within the terminal elements.

The JX-model, for the purpose of fulfilling the needs for various tools for Computer Aided Software Engineering (CASE), expresses a Java source program through a fine-grained abstraction thereof. In the JX-model, tags are directly attached to a source program, and styles such as indentation or line feed are maintained. Information can be captured from the XML repository using XML-related technologies such as a eXtensible Stylesheet Language Transformation (XSLT) or Document Object Model/Simple API for XML (DOM/SAX).

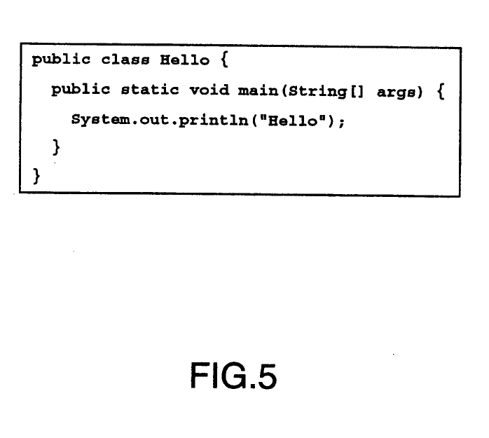

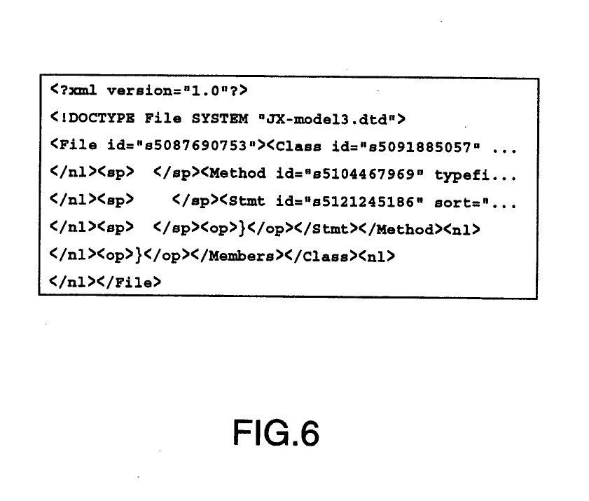

The XML repository based on the JX-model is created using “Japid,” which is well known by the article titled “A CASE Tool Platform for an Object Oriented Language,” co-authored by Yoshinari Hachisu, Shinichirou Yamamoto, and Kiyoshi Agusa, IEICE Trans. on Information and Systems, Vol. E82-D, No. 5, pp. 977-984 (May 1999). This is a part of the Sophisticated APIs for CASE tool Development (Sapid) (see, http://www.sapid.org/) that is designed to analyze a Java source program, wherein the Sapid is a well known platform for CASE tools. According to one example of the JX-model, the XML repository of the Java source program indicated in FIG. 5 is generated as shown in FIG. 6.

In the JSPIE2, it is designed that annotations are attached to ones of a plurality of objects of the JX-model that are classified as twenty types of elements excluding seven types of elements consisting of the “Members,” “Type,” “ident,” “kw,” “op,” “sp,” and “nl,” on a per element basis.

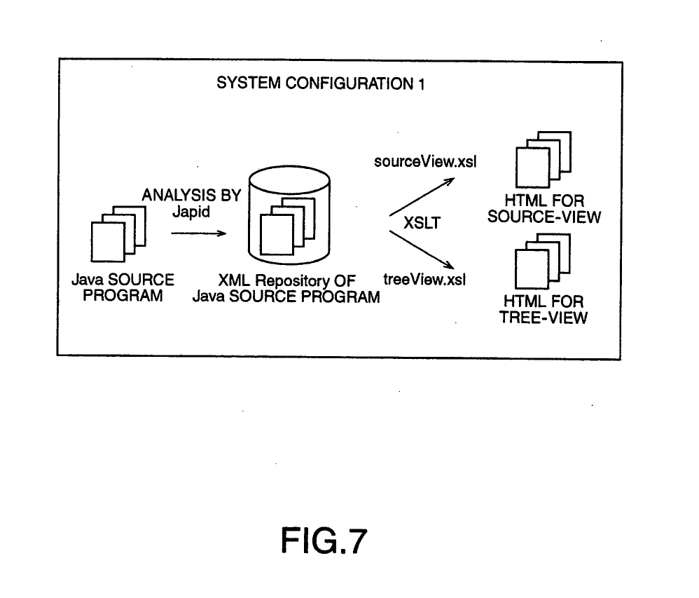

Now, the configuration of the system 1 is described in reference to FIGS. 7 to 10.

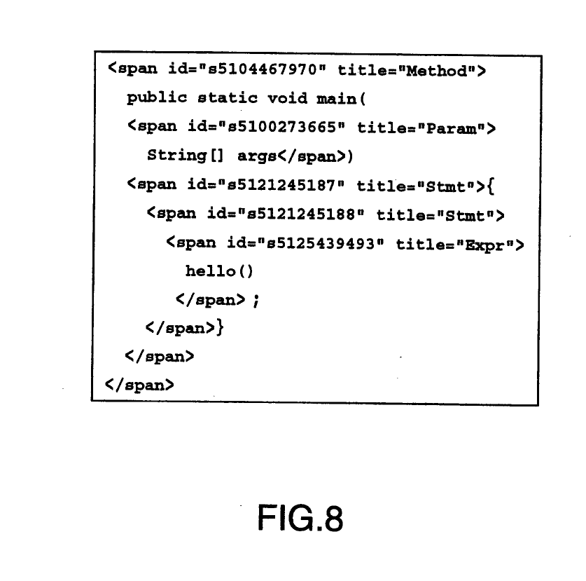

(1) To begin with, the configuration of the system 1 is described in reference to FIGS. 7 and 8 with respect to a process in which the server 10 generates data for displaying annotations using the XML repository.

First, as shown in FIG. 7, the XML repository is generated from a Java source program by the server 10 using the aforementioned Japid. Then, HTML for the tree-view and HTML for the source-view are generated. Along with the generation, XML for annotation data provided for storing annotation data is also generated, although it is not shown. This processing is performed once for a file-storing session.

The HTML for the source-view is utilized for displaying a source program as such, and for displaying the same source program as a basis utilized for allowing the user to attach annotations. One example of the HTML for the source-view is shown in FIG. 8. In the HTML for the source-view, a target object to be annotated is enclosed by “span” tags and the “id” and the “title” attributes are set as the “id” of the JX-model and the type of the target object, respectively.

Alternately, the HTML for the tree-view is a tree-structure alignment of sets of information respectively indicative of Class, Interface, Field, Method, and Constructor, which are derived from the XML repository.

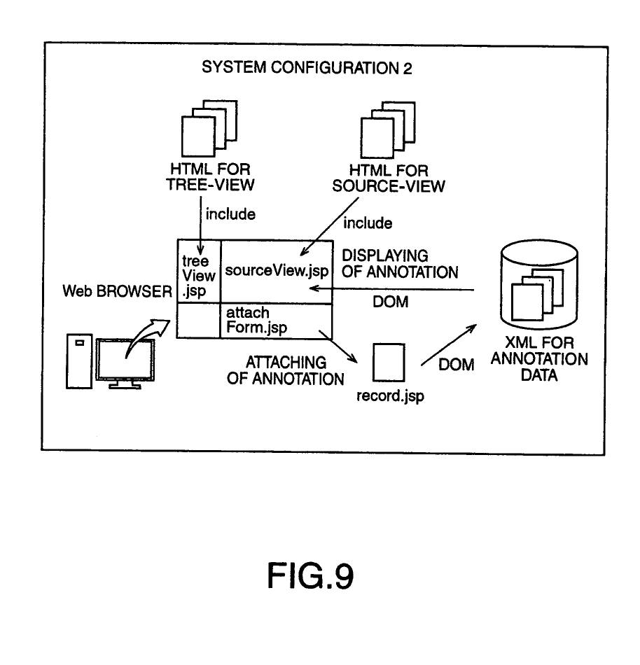

(2) Next, the configuration of the system 1 is described with respect to a processing performed at the time that annotations are attached and at the time that annotations are displayed, in reference to FIG. 9.

The annotation data entered by the user of the client computer 50 is transmitted to the server 10 from the aforementioned attach form, which is displayed by the Web browser of the client computer 50. The transmitted data is stored on the server 10 as XML for annotation data. The server 10 accesses required information from the stored XML for annotation data and then accesses the client computer 50 for the required information together with the HTML for the source-view.

The user clicking with the pointer being located within the source-view frame is conducted for attaching a new annotation to a document. In response to the user clicking, one of a plurality of objects displayed that has been pointed to by the mouse pointer is identified based on the “id” attribute of the “span” tags embedded in the HTML for the source-view and then the data is sent to the aforementioned attach form.

Data is respectively entered into the “object id” field, the “object” field (for the type of a target object), and the “position” field (for the position to which an annotation is to be attached) in the aforementioned attach form. The position of a document to be annotated is determined, as described above, using the relative coordinates of the mouse pointer. The position of a document to be annotated is defined as a relative position on a target object. Additionally, data is entered manually by the user into the “memo” field, the “title” field, the “name” field, and the “mail” field in the aforementioned attach form, respectively.

The thus generated annotation data with respect to the attach form is sent from the client computer 50 to the server 10. The annotation data, upon transmission to the server 10, is stored on the server 10 as XML for annotation data.

As shown in FIG. 9, the server 10 is operated such that a program “sourceView.jsp” accesses data from the XML for annotation data, then creates HTML for an annotation portion of the screen image, and then accesses the created HTML along with the HTML for the source-view to create the source-view frame of the client computer 50. The sourceView.jsp is, generally, a program written in JSP which is programming language specially designed to generate HTML, and in particular, a program designed to create HTML for the source-view.

The HTML transmitted to the source-view frame contains a JavaScript for allocating annotations that manipulates a “top” and a “left” attribute of a CSS for displaying a particular annotation at a desired position. The CSS is used to represent how data is displayed on the screen. The “top” attribute represents a distance of a corresponding pixel from the top edge of the screen in a pixel number. The “left” attribute represents a distance of a corresponding pixel from the left edge of the screen in a pixel number.

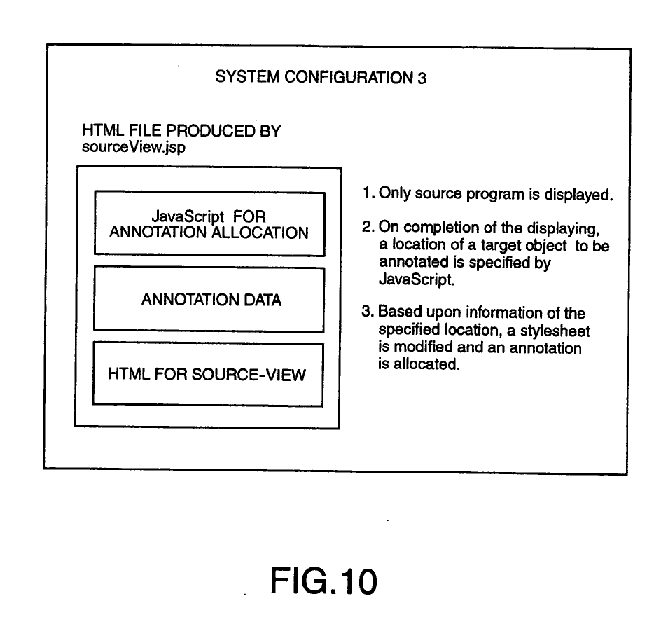

(3) Next, the configuration of the system 1 will be described with respect to the structure of a HTML file generated by the sourceView.jsp in reference to FIG. 10.

The HTML file generated by the sourceView.jsp is so constructed as to include the JavaScript for allocating annotations, the annotation data, and the HTML for the source-view, as shown in FIG. 10. The client computer 50, upon receiving and then implementing the HTML file, first displays a source program only. After completion of the display of the source program, the implementation of the JavaScript for allocating annotations would result in the determination of the position of a target object to be annotated, and further result in the modification of the style sheet and the allocation of annotations based on information relating to the determined position.

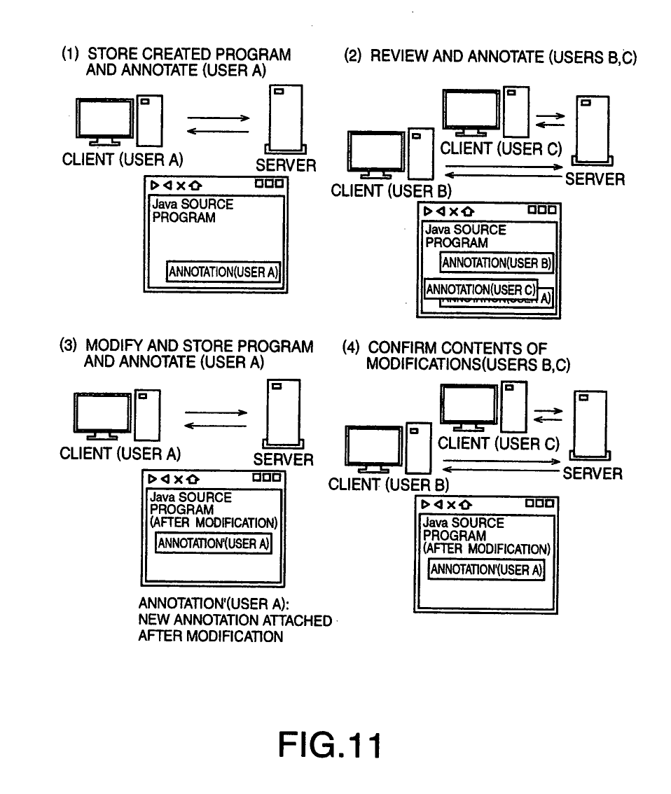

Now, one exemplary application of the JSPE2 is described in reference to FIG. 11. Assume the case where users B and C attempt to review, over the network, a source program that user A has created.

(1) First, user A enters the created source program into the JSPIE2. At the moment, user A adds to annotations, private or short-term information, such as a memorandum or notation, or messages that user A wishes to inform user B or C. User A may additionally write down formal or long-term information on a comment or a separate document.

(2) Next, users B and C review the source program, and then they add their comments to the source program, using annotations. If user B had reviewed the source program earlier than user C, user C would view not only the source program and the annotations previously made by user A, but also the annotations previously made by user B.

(3) Subsequently, user A, while viewing the annotations made by users B and C, modifies the source program, and then enters it again into the JSPIE2. While an unmodified version of the source program, to which annotations were attached before the modification of the source program, is kept to contain the same attached annotations still after the modification, a modified version of the source program does not contain any annotations. At this time, user A may add with annotations how he responded to several pieces of advice from users B and C or what user A newly noticed.

(4) Thereafter, users B and C check the modifications made by user A to the source program. If the modifications are not appropriate, the procedure described above is repeated.

When a programmer of a particular source program is able to communicate face to face with an inspector who is assigned to inspect the source program, it is not so difficult for the inspector to communicate with the programmer to, for example, point out the errors in the source program to the programmer, or inform the programmer of the inspector's comments or concerns about the source program. However, in the case where communication between the inspector and the programmer is required to be achieved over the network, or the like, communication between both parties is often difficult.

In the aforementioned case, the utilization of the JSPIE2 would, despite the inability of the inspector and the programmer to communicate face to face with each other, allow them to efficiently conduct collaborative work. As is evident from the above, the aforementioned case is considered to be one exemplary effective application of the JSPIE2.

There has been described above the inventive browser software JSPIE2 containing communication functions using annotations. The invention exploits XML technologies (e.g., XML, XSLT, DOM) and Web technologies (e.g., JSP, JavaScript, CSS) to develop the system 1 that allows the user of the client computer 50 to annotate a source program through the Web browser of the client computer 50.

The employment of the system 1 would permit communication to be handled using annotations on a source program, resulting in an effective support of the user in understanding a program where the user is required to understand the program, such as where the user is required to reuse or maintain the program.

Other exemplary applications of the JSPIE2 can be seen as follows.

(1) Collaborative Development

The JSPIE2 is utilized for sharing and exchanging information between members of a group on a project for collaborative development, for the purposes of review via the network as exemplified above or the like. In this case, communication achieved over the JSPIE2 allows an efficient progress of collaborative development.

(2) Publication of Source Program

For publication of a source program, the source program is not merely published, but published using the JSPIE2. In this case, not only members of a group on a development project of a particular source program, but also other persons are allowed to view the same source program using the corresponding Web browser, whereby the other persons are allowed to participate in the communication between the members. This, therefore, makes it possible for the members on the development project to collect more information on their source program.

(3) Tutorial

While tutorial sessions of a program are generally conducted in a manner that a sample program is prepared and then the explanation is provided by the tutor to the students, it is proposed that the sample program be presented using the JSPIE2, along with attached annotations containing the explanation. This manner would make it easier for the tutor to add the explanation to the sample program using annotations, and therefore would result in an easier preparation by the tutor of materials for tutorial. In addition, that manner would allow the students to see the sample program with attached annotations, and therefore would facilitate the students' understanding of the sample program. It is also proposed that not only the tutor but also the students add to the sample program unsolved matters or questions using annotations, for bi-directional communication between the tutor and the students. The utilization of the JSPIE2 in a manner described above would allow tutorial sessions to be efficiently run.

While the system 1 has been described above with respect to the case where a document to be annotated is a Java source program, the system 1, which allows information to be shared and exchanged using annotations, may also be effectively utilized also for a separate type of a document to be annotated. Such a document may be a source program written in another programming language, a document related to software, a general document, or the like.

As is readily understood from the above, the system 1 would allow information stored on electronic annotations to be utilized by workers via the network and to be shared among the workers, whereby on-line communication via annotations is achieved for the same target document. Additionally, the system 1 would permit temporal information occurring while the user is viewing a particular document to be stored and administered in the form of electronic annotations.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A method for causing a server to provide on-line and on-demand to a client computer, which is connected with the server via a network and which has a Web browser, an annotation function available to other client computers, to thereby allow the client computer to communicate with the other client computers using annotations, the method comprising:
a storing step of storing on the server, by the server, viewing information that allows a user of the client computer to view a document with an attached annotation on a screen of the client computer; and
a transmitting step of transmitting, by the server, in response to a request of the user to view the document, the viewing information to the client computer, the viewing information including:
(a) document information representing the document in a format that allows the user to view the document by the Web browser, such that the document is defined so as to be classified into a plurality of objects which are capable of being designated individually;
(b) annotation information representing the annotation in a format that allows the user to view the annotation by the Web browser, the annotation information including position information defining a position that the annotation is to be displayed by the Web browser with the annotation being attached to the document, in association with a corresponding one of the plurality of objects; and
(c) a script to be executed by the client computer for allocating the annotation to the document.

2. The method according to claim 1, wherein the annotation information is expressed in an HTML format, and wherein the script is expressed in script language that can be processed by the client computer, the script being executed by the client computer such that the annotation is allocated to the document based on the annotation information and manipulation of the client computer by the user.

3. The method according to claim 1, wherein the document is constructed by the plurality of objects in a hierarchical form, and wherein the annotation information includes display information for displaying the document and the annotation on the screen of the client computer such that a screen image of the screen is divided into a source-view frame, a tree-view frame, a menu frame, and a subframe, the display information including:
(a) information for displaying the document with the annotation in the source-view frame;
(b) information for displaying a hierarchical structure of the document in the tree-view frame in a tree structure form;
(c) information for displaying a list of commands that can be selected by the user in the menu frame; and
(d) information for displaying a list of annotations attached to the document in the subframe.

4. The method according to claim 1, further comprising a displaying step of displaying, by the client computer, based on the viewing information transmitted from the server, the document with the annotation at a position associated with a position at which one of the plurality of objects that the annotation has been previously associated with has been displayed on the screen.

5. The method according to claim 1, wherein the storing step further stores on the server attach information that allows the user to attach an annotation to a document at the client computer, the attach information including:
(a) server-processed information to be processed by the server for allowing the user of the client computer to attach an annotation; and
(b) client-processed information to be processed by the client computer for allowing the user of the client computer to attach an annotation.

6. The method according to claim 5, further comprising:
transmitting, by the server, in a state that the document has been displayed in the form of a combination of the plurality of objects on the screen of the client computer, in response to a request of the user representing that the user wishes to attach a separate annotation to the document, the client-processed information to the client computer; and
specifying, by the client computer, in response to an action of the user to designate a desired annotation position at which the user desires to attach the separate annotation to the document, based on the client-processed information transmitted from the server, one of the plurality of objects that are displaying within which the desired annotation position is disposed, as a target object, to thereby define a display position of the separate annotation in association with a display position of the target object.

7. The method according to claim 6, further comprising:
receiving, by the server, annotation data representing a content of the separate annotation, and the defined display position of the separate annotation, from the client computer; and
updating, by the server, based on the transmitted annotation data and the server-processed information, the viewing information so as to reflect the separate annotation.

8. The method according to claim 6, wherein the separate annotation is displayed, based on relative coordinates of the desired annotation position relative to a reference position that has been previously assigned to the specified target object, at a position associated with the target object on the screen of the client computer.

9. The method according to claim 8, wherein the separate annotation is temporally moved on the screen of the client computer in response to dragging of the separate annotation by the user, irrespective of values of the relative coordinates.

10. The method according to claim 5, wherein the client-processed information includes form information that causes the client computer to display on the screen a form that allows the user to enter data required to attach the separate annotation into the client computer on a per item basis, and wherein the annotation data is created at the client computer in an HTML format, depending upon entry by the user into the displayed form, while the annotation data is stored on the server in an XML format.

11. A computer-readable recording medium having stored therein the viewing information defined in claim 1.

12. A carrier wave encoding the viewing information defined in claim 1.

13. A method for causing a client computer, which is connected with the server via a network and which has a Web browser, to receive on-line and on-demand from the server an annotation function available to other client computers, to thereby allow the client computer to communicate with the other client computers using annotations, the method comprising:
receiving, by the client computer, viewing information that allows a user of the client computer to view a document with an attached annotation on a screen of the client computer; and
displaying, by the client computer, based on the viewing information transmitted from the server, the document with the annotation at a position associated with a position at which one of the plurality of objects that the annotation has been previously associated with has been displayed on the screen, the viewing information including:
(a) document information representing the document in a format that allows the user to view the document by the Web browser, such that the document is defined so as to be classified into a plurality of objects that are capable of being designated individually;
(b) annotation information representing the annotation in a format that allows the user to view the annotation by the Web browser, the annotation information including position information defining a position that the annotation is to be displayed by the Web browser with the annotation being attached to the document in association with a corresponding one of the plurality of objects; and
(c) a script to be executed by the client computer for allocating the annotation to the document.
